(19) United States
(12) Patent Application Publication
(10) Pub. No.: US 2024/0391642 A1
(43) Pub. Date: Nov. 28, 2024

(54) PRODUCT TRANSFER SYSTEM

(71) Applicant: ORBIS Corporation, Oconomowoc, WI (US)

(72) Inventors: Benjamin Joel Thompson, Watertown, WI (US); Robert Guy Nussbaum, Oconomowoc, WI (US)

(21) Appl. No.: 18/667,570

(22) Filed: May 17, 2024

Related U.S. Application Data
(60) Provisional application No. 63/468,303, filed on May 23, 2023.

(51) Int. Cl. B65D 19/18; B65D 19/44

(52) U.S. Cl. CPC B65D 19/18; B65D 19/44; B65D 2519/00069; B65D 2519/00393; B65D 2519/00781; B65D 2519/00995

(57) ABSTRACT

A product transfer system including a first base member, such as a pallet or dolly, supporting a first sleeve having a back wall, a first side wall and a second side wall, and a second base member supporting a second sleeve having a back wall, a first side wall and a second side wall. A first connector, such as a bar or netting, can connect the first sleeve to the second sleeve to provide stability to the system. Netting can also be used to span the front of the sleeve from side wall to side wall. A top cap can be placed on top of each of the first sleeve and the second sleeve.

### CROSS-REFERENCE TO RELATED APPLICATIONS

The present invention claims priority to and the benefit of U.S. Provisional Patent Application No. 63/468,303, filed May 23, 2023, the contents of which are incorporated herein by reference and made a part hereof.

### FEDERALLY SPONSORED RESEARCH OR DEVELOPMENT

N/A

### FIELD OF THE INVENTION

The present invention is directed toward a product transfer system in the form of a first base member, such as a pallet or dolly, supporting a three walled sleeve and a second base member supporting a three walled sleeve that are connected together during transport.

### DESCRIPTION OF THE PRIOR ART

Typical large pallets (e.g., 40″×48″) used to transfer products can be problematic for small format stores. Such pallets can be too large to fit through doors and/or be moved down aisles in such locations. Instead, the product on such large pallets must be transferred to other systems, such as a roll-trainer (e.g. a metal cart with wheels having a 24″×42″ footprint) that can fit through the doors and aisles.

The present invention provides a system that can be transported to a location in the same manner as a typical (large) pallet, and then can be broken down into smaller units which can fit through small format doors and aisles.

### SUMMARY OF THE INVENTION

The present invention is generally directed to a product transfer system that includes a first base member, such as a small format pallet or a dolly, and a sleeve and a second base member (again, such as a small format pallet or dolly) and sleeve—positioned side by side—that are connected together to provide stability during transport. The system can also include top caps and netting for each sleeve.

In accordance with one aspect of the invention, a product transfer system comprises a first base member having an upper surface and a first sleeve having a back wall, a first side wall extending from a first side of the back wall and a second side wall extending from a second side of the back wall where the first sleeve is supported on the upper surface of the first pallet. The system also includes a second base member having an upper surface and a second sleeve having a back wall, a first side wall extending from a first side of the back wall and a second side wall extending from a second side of the back wall where the second sleeve is supported on the upper surface of the second pallet. A first connector connects the first sleeve to the second sleeve. The first sleeve is positioned such that the back wall of the first sleeve is adjacent to the back wall of the second sleeve, and the respective side walls extend in opposite directions. The first and second base members can be small format pallets, dollies, or other similar structures. Preferably, the main components of the pallets or dollies are formed primarily from a molded plastic.

The first connector can be a first bar spanning across the top of the first and second sleeve. Alternatively, netting can be connected to both the first sleeve and the second sleeve. In both instances, the first connector provides stability to the system as it is being transported. Additional connectors can be utilized to provide additional support and stability.

A first rod can be connected to the first side wall of the first sleeve and a second rod connected to the second side wall of the second sleeve. The first rod is embedded in the first side wall of the first sleeve and the second rod is embedded in the second side wall of the second sleeve. The first bar can be connected to the first rod and to the second rod to provide stability to the system.

A portion of the first rod can extend upward above a top edge of the first side wall of the first sleeve and a portion of the second rod can extend upward above a top edge of the second side wall of the second sleeve. The first bar can include a first opening for receiving the portion of the first rod that extends upward above the top edge of the first side wall of the first sleeve and a second opening for receiving the portion of the second rod that extends upward above the top edge of the second side wall of the second sleeve.

A third rod can be connected to the second side wall of the first sleeve and a fourth rod can be connected to the first side wall of the second sleeve. The third rod can be embedded in the second side wall of the first sleeve and the fourth rod can be embedded in the first side wall of the second sleeve. A portion of the third rod can extend upward above a top edge of the second side wall of the first sleeve and a portion of the fourth rod can extend upward above a top edge of the first side wall of the second sleeve. A second bar can be connected to the third rod and the fourth rod. The second bar can include a first opening for receiving the portion of the third rod that extends upward above the top edge of the second side wall of the first sleeve and a second opening for receiving the portion of the fourth rod that extends upward above the top edge of the first side wall of the second sleeve.

The system can include a first front netting that extends from the first side wall of the first sleeve to the second side wall of the first sleeve, and a second front netting that extends from the first side wall of the second sleeve to the second side wall of the second sleeve. The system can also include a first top cap on the first sleeve and a second top cap on the second sleeve.

The first base member of the system can be a first molded plastic pallet having a plurality of legs extending downward from the upper surface and the second base member can be a second molded plastic pallet having a plurality of legs extending downward from the upper surface. The first sleeve can be secured to the first pallet by a first latch and the second sleeve can be secured to the second pallet by a second latch. The upper surface of the pallets can be rectangular and have a width of approximately 24 inches and a length of approximately 48 inches.

In accordance with another aspect of the invention, a product transfer system comprises a first pallet having an upper surface and a first sleeve having a back wall, a first side wall extending from a first side of the back wall and a second side wall extending from a second side of the back wall where the first sleeve is supported on the upper surface of the first pallet and a second pallet having an upper surface and a second sleeve having a back wall, a first side wall extending from a first side of the back wall and a second side wall extending from a second side of the back wall where the second sleeve is supported on the upper surface of the second pallet. A netting is connected to the first side wall of the first sleeve and the second side wall of the second sleeve to provide stability during transport.

The netting can be connected to the first side wall of the first sleeve and the second side wall of the second sleeve by cinch straps. Alternatively, the netting can be connected to the first side wall of the first sleeve and the second side wall of the second sleeve by hooks.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1 is a perspective view of a product transport system on a fork lift including pallet base members in accordance with an aspect of the present invention;

FIG. 2 is a side view of the product transport system of FIG. 1;

FIG. 3 is an end view of the product transport system of FIG. 1;

FIG. 4 is a top perspective view of the product transport system of FIG. 1;

FIG. 5 is a bottom view of the product transport system of FIG. 1;

FIG. 6 is a perspective view the product transport system showing only one of the sleeves of the system;

FIG. 7 is a partially exploded perspective view of the product transport showing one of the bars above the system;

FIG. 8 is a perspective view of a bar from the product transport system of FIG. 1;

FIG. 9 is a perspective view of a single base member in the form of a pallet and sleeve unit showing a net across a front opening of the sleeve;

FIG. 10 is a perspective view of the single pallet and sleeve of FIG. 9 with a top cap;

FIG. 11 is a perspective view of product transport system in accordance with another aspect of the present invention;

FIG. 12 is a perspective view of a hook that can be used with the product transport system of FIG. 11;

FIG. 13 is a perspective partial view of a channel in the base member of the product transportation system showing an inward protrusion used to latch or hold a sleeve to the base member;

FIG. 14 is an outer view of the inward protrusion of FIG. 13;

FIG. 15 is a perspective partial view of a sleeve and an inward protrusion of the base member;

FIG. 16 is a perspective view of a product transfer system on a fork lift including dolly base members in accordance with another aspect of the present invention;

FIG. 17A is an upper perspective view of a dolly which is used as the base members in FIG. 16;

FIG. 17B is a lower perspective view of a dolly which is used as the base members in FIG. 16

FIG. 18 is a lower view of the product transfer system of FIG. 16;

FIG. 19 is a perspective view of single dolly and sleeve with a removable handle;

FIG. 20 is a perspective view of the handle of FIG. 19 with its arms in an extended position and a retracted position;

FIG. 21 is a perspective view of a first dolly and sleeve combination with a handle and a second dolly and sleeve combination with a training connector to the first dolly and sleeve combination;

FIG. 22 is a perspective view showing the training connector of FIG. 21 in an extended position and a retracted position; and,

FIG. 23 is a perspective view illustrating a plurality of product transfer systems of FIG. 16 in a truck.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

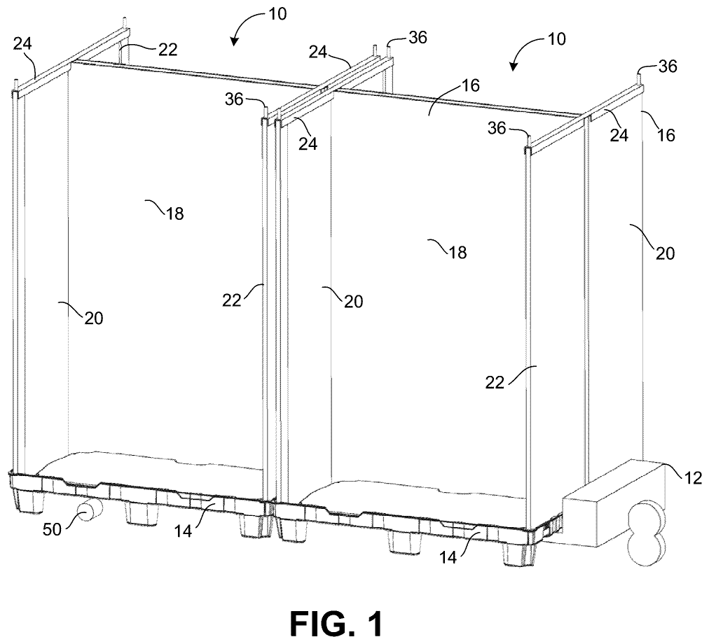

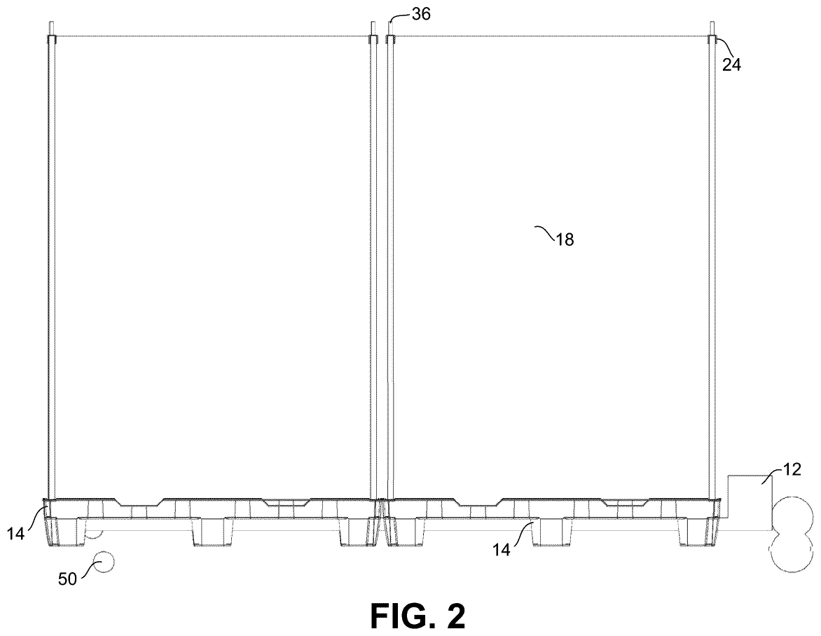

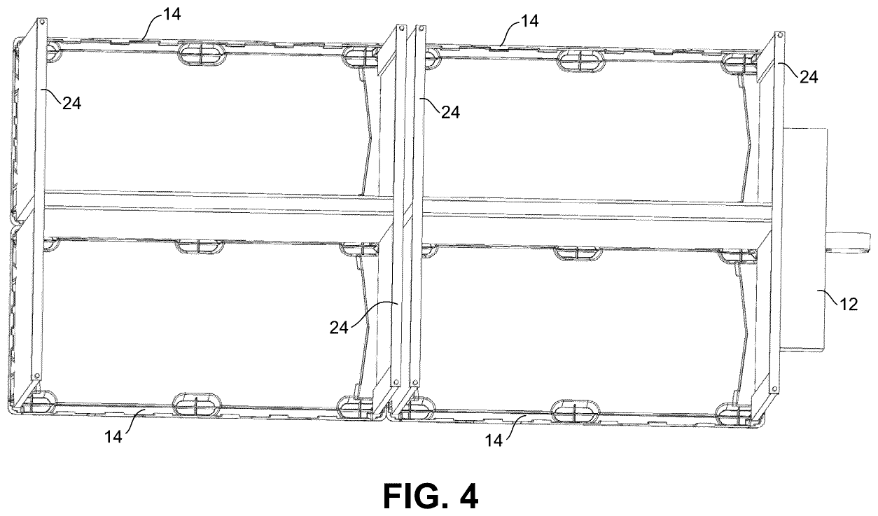

FIGS. 1-5 show two product transfer systems 10 in accordance with an aspect of the present invention, on the tines of a fork lift 12 (illustrated schematically). Each product transfer system 10 includes a first base member in the form of a small format pallet 14 and second base member, also in the form of a small format pallet 14, positioned side by side, with each of the pallets 14 supporting a first sleeve 16 and a second sleeve 16, respectively. Each sleeve 16 includes a back wall 18, a first flap or side wall 20 extending perpendicular from one side of the back wall 18 and a second flap or side wall 22 extending perpendicular from a second side of the back wall 18. The sleeves 16 are positioned on the two pallets 14 facing opposite directions, such that the back walls 18 are next to each other, and the respective side walls 20, 22 are extending in opposite directions.

The two pallets 14 and sleeves 16 of each product transfer system 10 are coupled to each other by a first connector in the form of a first bar 24 connected to the top edges of the first side wall 20 of the first sleeve 16 and the second side wall 22 of the second sleeve 16, and a second connector in the form of a second bar 24 connected to the top edges of the second side wall 22 of the first sleeve 16 and the first side wall 20 of the second sleeve 16.

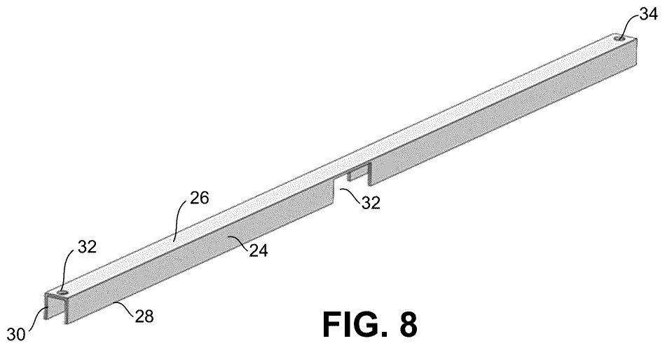

As shown in FIG. 8, each bar 24 has a horizontal top segment 26, a downwardly extending, vertical first segment 28 perpendicular to and on one side of the horizontal segment 26 and a downwardly extending, vertical second segment 30 perpendicular to and on an opposing side of the horizontal segment 26. The top segment 26, first segment 28 and second segment 30 form an inverted, generally squared off U-shape, dimensioned to snuggly fit over the top edges of the sleeves 16. The first and second segments 28, 30 include a central opening or cut-away 32 to accommodate the back walls 18 of the sleeves 16. Additionally, the top segment 26 includes a first opening 34 at one end and a second opening 36 at a second end.

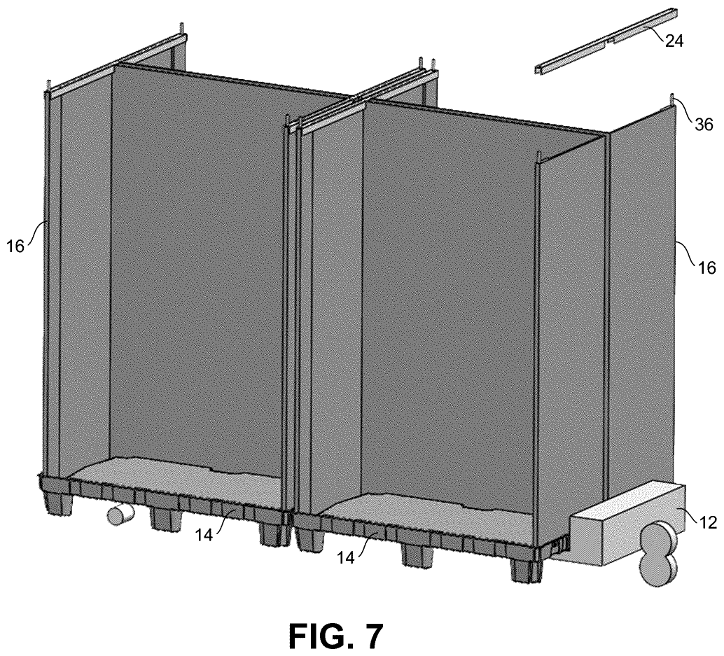

Both the first side wall 20 and the second side wall 22 included an embedded rod 36 at an end of the side wall remote from the back wall 18. The rod includes a portion extending upward above the top edge of the side wall 20, 22. The first and second openings 32, 34 on the bar 24 are positioned to fit over the extending portions of the rods 36 to help secure the bar 24 to the two sleeves 16. FIG. 7 shows one of the bars 24 positioned above one of the product transfer systems 10 in a position to be lowered over the extending portions of the rods 36. In the present arrangement, the bar 24 can be quickly placed on or removed from the system 10.

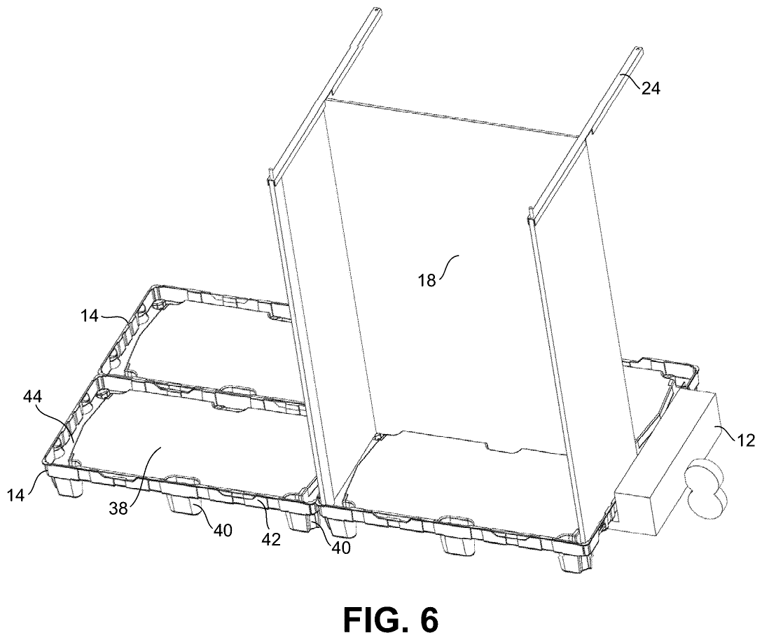

The pallets 14, several of which are shown without the sleeve in FIG. 6, include a support surface 38 and a plurality of legs 40 extending downward from the support surface 38. A wall 42 extends around the periphery of the support surface 38 and is separated from the support surface 38 by a well or channel 44. The side walls 20, 22 and back wall 18 of the sleeve 16 can be positioned in the channel 44.

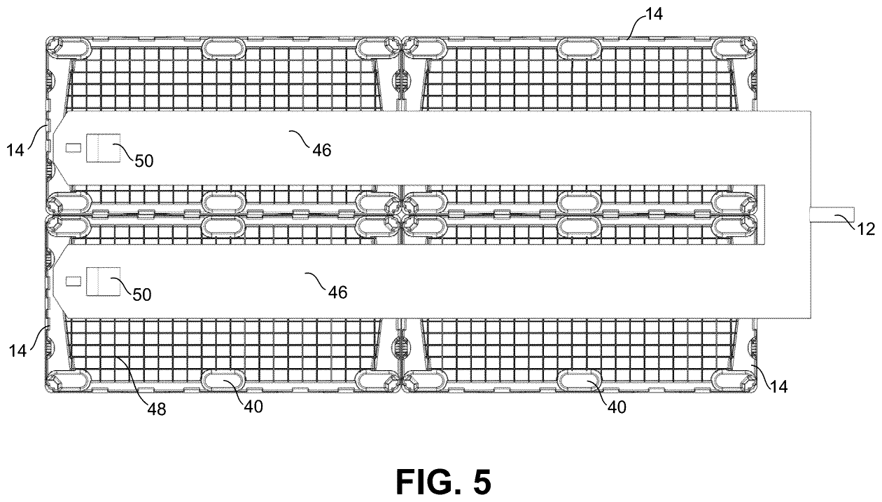

As shown in FIG. 5, the pallets 14 are supported on the tines 46 of the forklift 12. The forklift also includes wheels 50 (again, shown schematically) for moving the systems 10. As also illustrated, the pallets 14 can include a plurality of ribs 48 that extend downward from a lower surface of the support surface 38.

The pallets 14 are small format and have a footprint of 24×48 inches. Two of the pallets 14, positioned side by side as shown in the Figures, have a footprint slightly greater than a standard 40×48 inch pallet. The sleeve has a height of 65 inches.

While the rods 36 are embedded at an end of the side walls 20, 22, additional rods can be utilized at other locations (or instead of at the ends). Alternatively, the sleeves 16 can be provided with just the extensions (above the top edges) or other similar structure for securing the bars to the sleeve. Alternatively or in addition, structures connecting the back walls 18 to each other can be utilized.

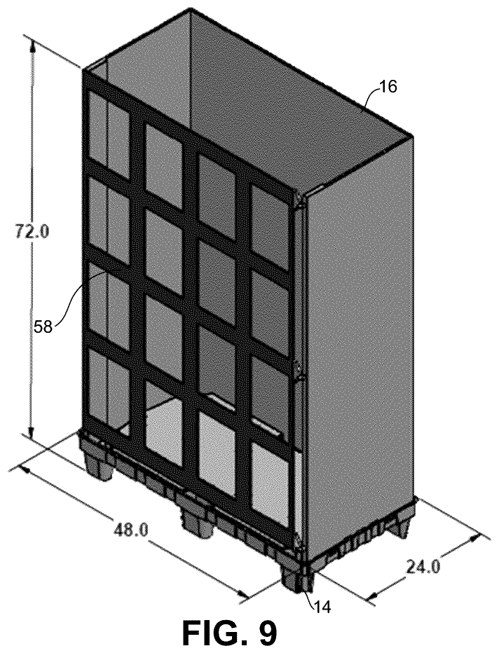

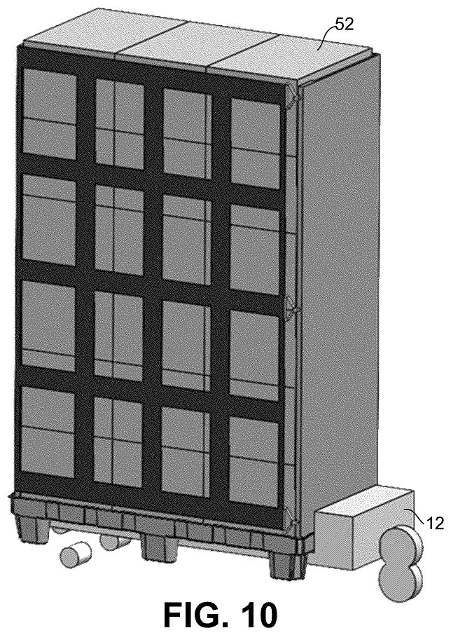

Each sleeve 16 can be provided with netting 58 (or other similar structure) that can extend across the open side of the sleeve 16 (as shown in FIGS. 9 and 10), to enclose any products stored on the pallet 14. Additionally, each sleeve 16 can be fitted with a top cap 52 (shown in FIG. 10).

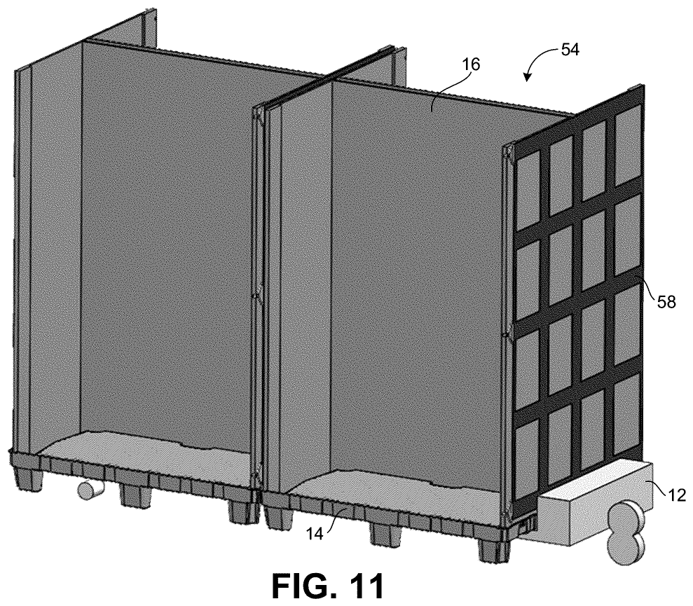

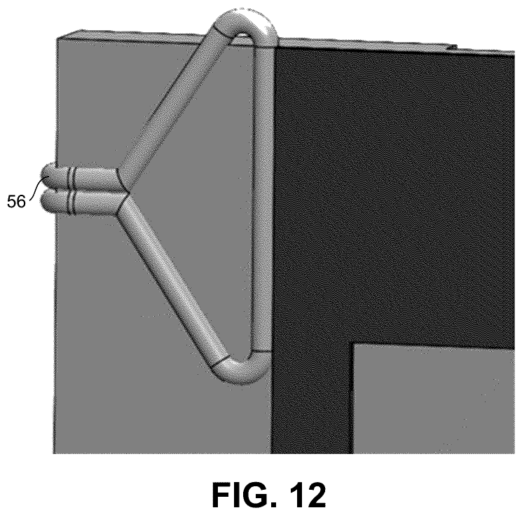

The netting 58 can be utilized as a connector in an alternative product transfer system 54 illustrated in FIGS. 11 and 12. In this aspect of the invention, the netting 58 is draped over the sides 20, 22 of two sleeves 16 and is connected by hooks 56, or other structures, such as cinch straps. The netting 58 provides the stability to the system in place of the bar 24.

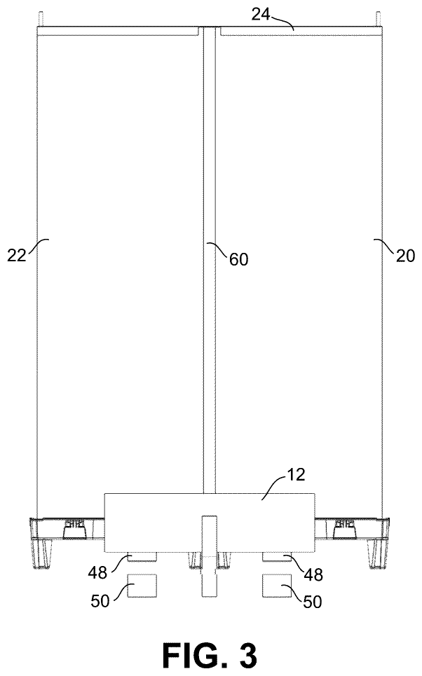

The pallets 14 in each product transfer system 10 shown in FIGS. 1-6 are positioned adjacent and potentially abutting each other. The sleeves 16 supported on the pallets 14 are slightly separated. As shown in FIG. 3 there is a small gap 60 between the back walls 18 of the sleeves 16.

While FIGS. 1-6 show two separate product transfer systems 10 supported on the forklift 12, it is possible to provide structure connecting the systems to provide additional stability during transport.

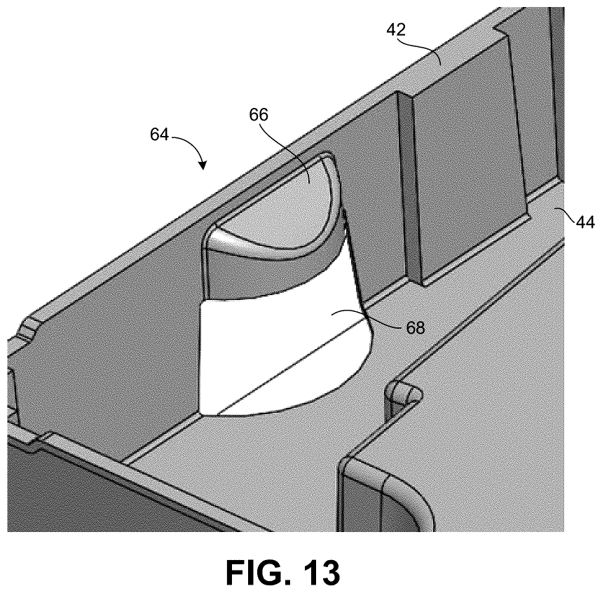

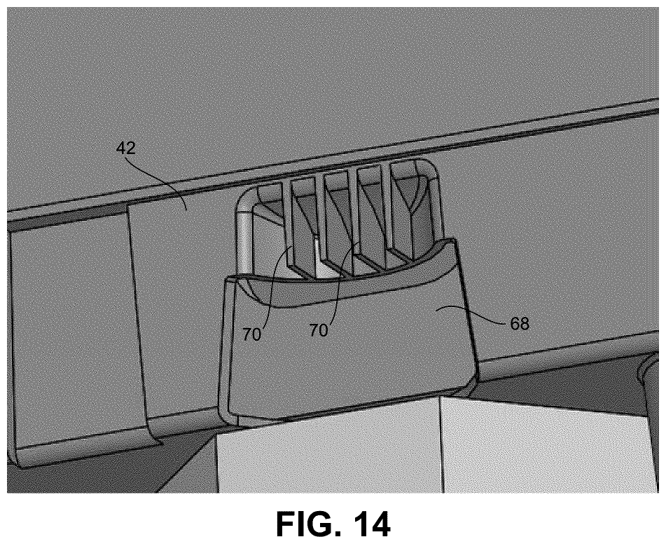

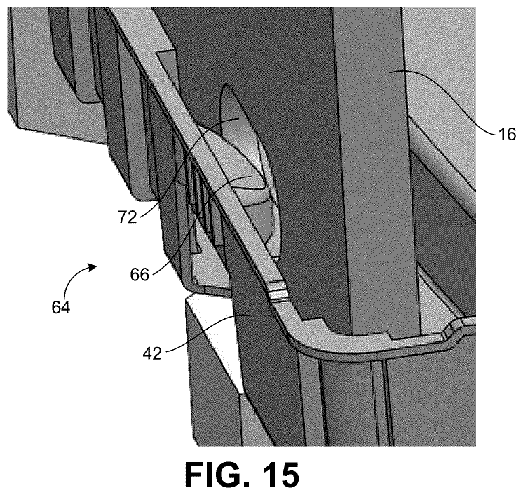

As illustrated in FIGS. 13-15, a latch mechanism 64 in the channel 44 can be used to secure the sleeve 16 to the pallet 14. The mechanism 64 includes an inwardly extending protrusion 66 above an opening 68 in the outer wall 42 of the pallet 14. The protrusion 66 has a generally arcuate shape. As shown in FIG. 14, the protrusion 66 can include a plurality of support ribs 70 extending downward from a lower surface of the protrusion 66. The protrusion 66 cooperates with an opening 72 in the sleeve 16 as generally illustrated in FIG. 15 to secure the sleeve 16 to the pallet 14. The pallet 14 can include a plurality of latch mechanisms 64 around the pallet 14. Additionally, the latch can be formed with a protrusion extending outward from the inner wall of the channel 44.

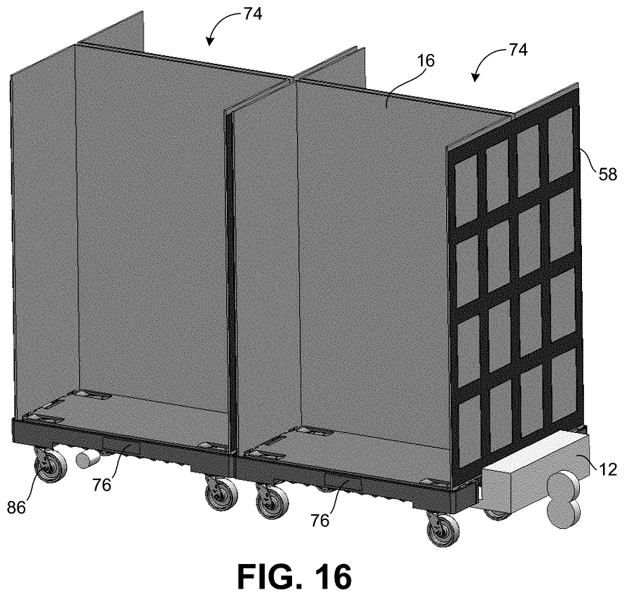

An alternative aspect of the invention utilizing a dolly as the base member is illustrated in FIGS. 16-23. Instead of using two small format pallets, a product transfer system 74 shown in FIG. 16 uses two dollies 76 to form the base members supporting sleeves 16. The system 74 is shown with netting 58 connecting the sleeves 16 supported on the two dollies 76, however bars 24 (as discussed above) and other similar structure could be utilized to couple the sleeves 16 to provide stability to the system 74.

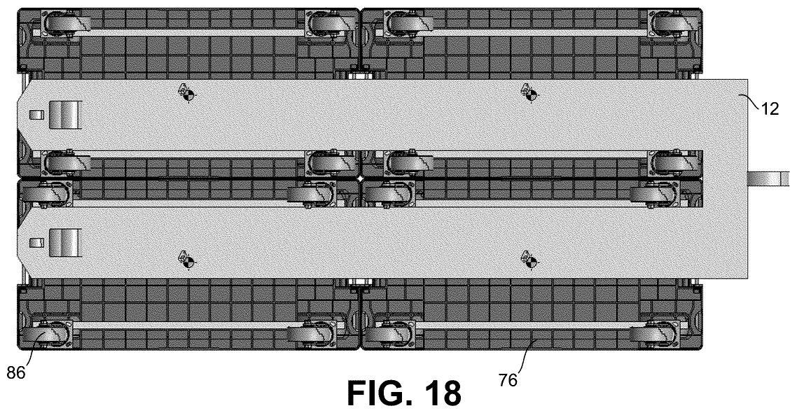

Two product transfer systems 74 using dollies 76 as the base members are shown in FIG. 16 positioned on a fork lift 12. A lower view of the dollies 76 on the fork lift 12 is shown in FIG. 18.

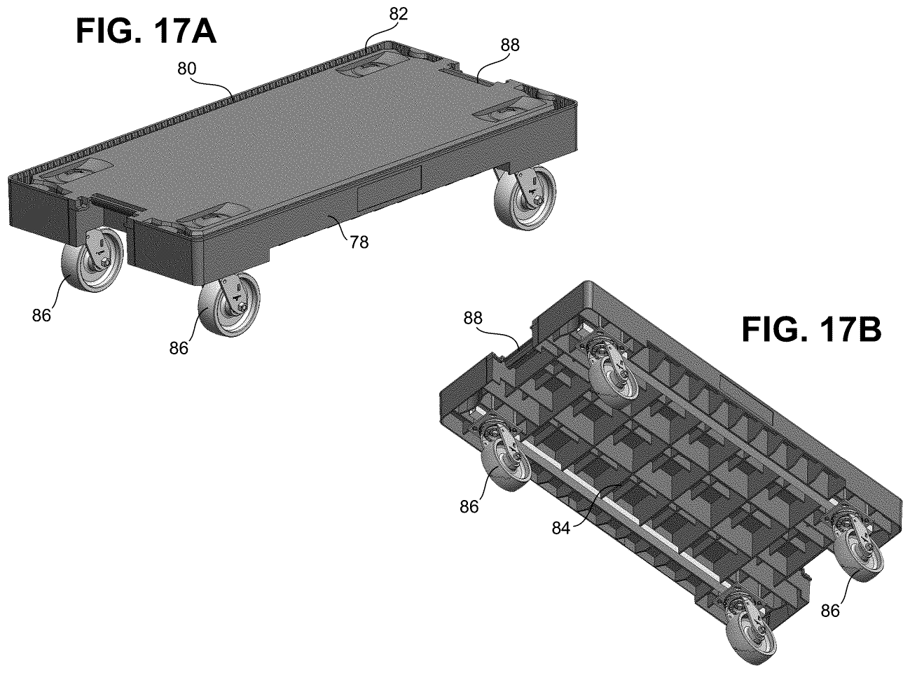

A dolly 76 for use as a base member for the product transfer system 74 is shown without the sleeve 16 or other components of the product transfer system 74 in FIGS. 17A and 17B. The dolly 76 includes a flat upper platform 78 having a support surface 80 with an outer channel 82 along the perimeter of the upper surface 80. The upper platform 78 can be formed from an injection molded plastic or other similar or suitable materials. A plurality of support ribs 84 extend downward from the upper surface 80 as shown in FIG. 17B. Four wheels 86 on swivel casters extend downward from the upper platform 78.

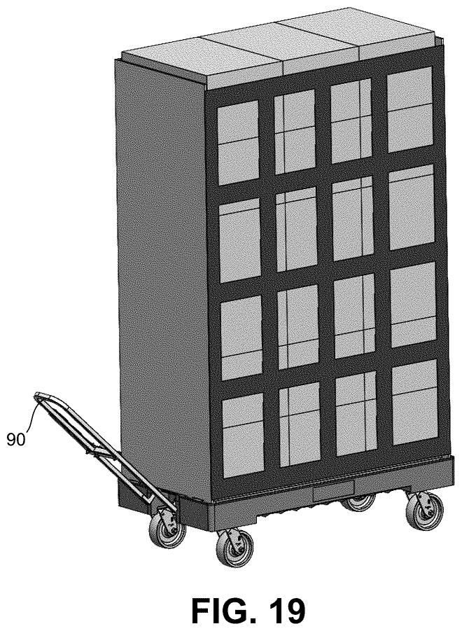

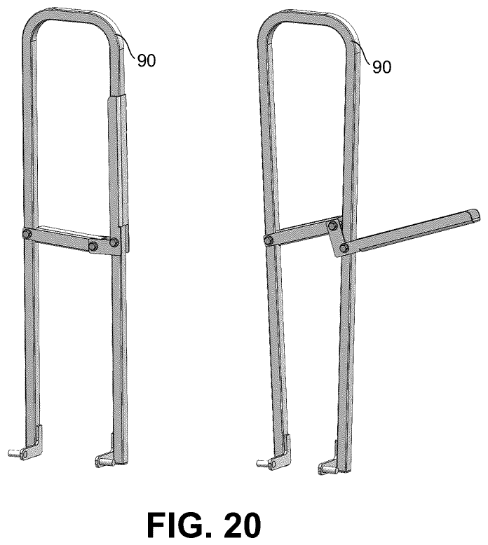

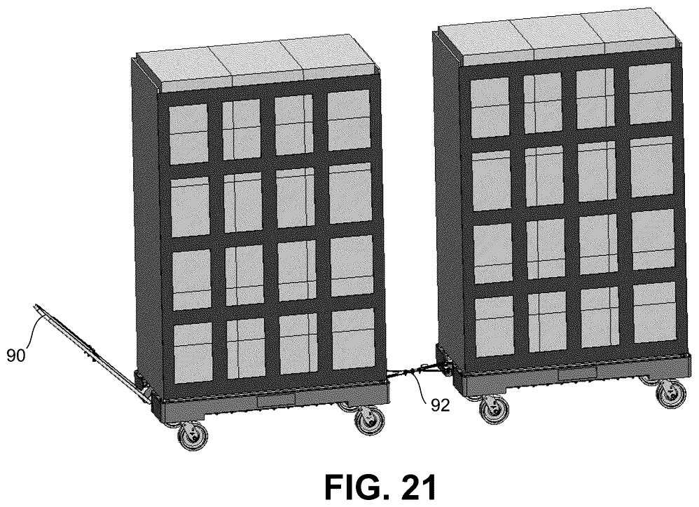

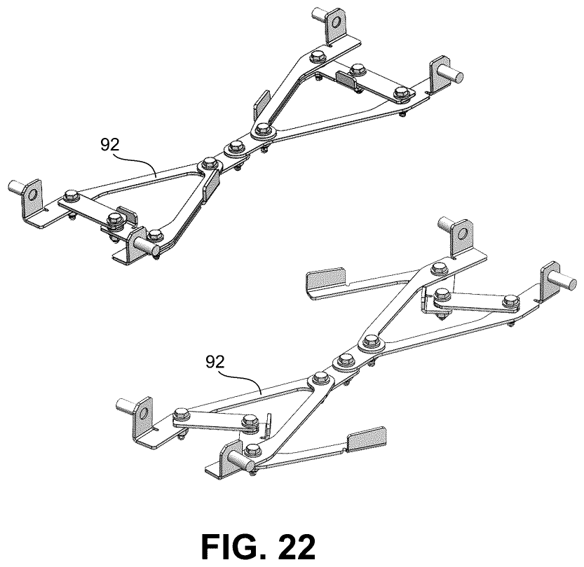

The upper platform 78 includes both a front and rear inset 88 having side openings for receiving prongs from attachable items to the dolly 76. The insets 88 are configured to receive removable handles 90 as illustrated in FIGS. 19 and 20, and/or training connectors 92 as illustrated in FIGS. 21 and 22. The handles 90 or training connectors 92 are typically utilized after the product transfer system 74 is conveyed to its location and the system 74 is uncoupled.

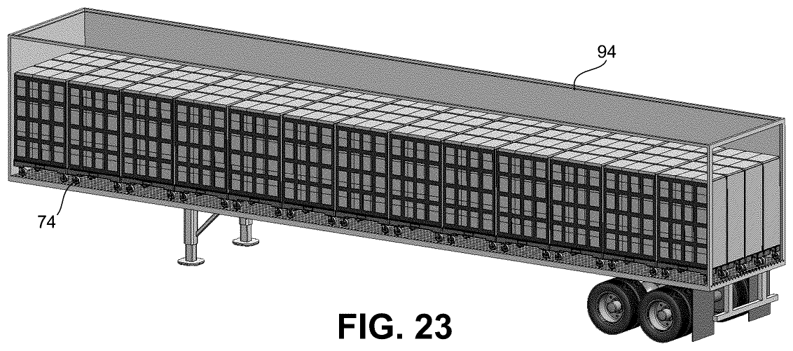

FIG. 23 illustrates how a plurality of the product transfer systems 74 are loaded in the trailer portion 94 of a truck. A typical trailer 94 can support fifty two product transfer systems 74.

Many modifications and variations of the present invention are possible in light of the above teachings. It is, therefore, to be understood within the scope of the appended claims the invention may be protected otherwise than as specifically described.

We claim:

1. A product transfer system comprising:
a first base member having a first upper surface;
a first sleeve having a back wall, a first side wall extending from a first side of the back wall and a second side wall extending from a second side of the back wall, the first sleeve supported on the first upper surface of the first base member;
a second base member having a second upper surface;
a second sleeve having a back wall, a first side wall extending from a first side of the back wall and a second side wall extending from a second side of the back wall, the second sleeve supported on the second upper surface of the second base member;
a first connector connecting the first base member and first sleeve to the second base member and second sleeve.

2. The product transfer system of claim 1 wherein the first base member is a pallet having an upper portion and a plurality of legs extending downward from the upper portion.

3. The product transfer system of claim 1 wherein the first base member is a dolly having an upper portion and a plurality of wheels extending downward from the upper portion.

4. The product transfer system of claim 1 wherein the first connector is a first bar connected to a top portion of the first sleeve and the second sleeve.

5. The product transfer system of claim 4 comprising a first rod connected to the first side wall of the first sleeve and a second rod connected to the second side wall of the second sleeve.

6. The product transfer system of claim 5 wherein the first bar is connected to the first rod and to the second rod.

7. The product transfer system of claim 6 wherein the first rod is embedded in the first side wall of the first sleeve and the second rod is embedded in the second side wall of the second sleeve.

8. The product transfer system of claim 6 wherein a portion of the first rod extends upward above a top edge of the first side wall of the first sleeve and a portion of the second rod extends upward above a top edge of the second side wall of the second sleeve.

9. The product transfer system of claim 8 wherein the first bar includes a first opening for receiving the portion of the first rod that extends upward above the top edge of the first side wall of the first sleeve and a second opening for receiving the portion of the second rod that extends upward above the top edge of the second side wall of the second sleeve.

10. The product transfer system of claim 9 comprising a third rod connected to the second side wall of the first sleeve and a fourth rod connected to the first side wall of the second sleeve.

11. The product transfer system of claim 10 wherein the third rod is embedded in the second side wall of the first sleeve and the fourth rod is embedded in the first side wall of the second sleeve.

12. The product transfer system of claim 11 comprising a second bar connected to the third rod and the fourth rod.

13. The product transfer system of claim 1 comprising a first netting connected to the first sleeve.

14. The product transfer system of claim 13 wherein the first netting is utilized as the first connector and is further connected to the second sleeve.

15. The product transfer system of claim 14 wherein the first netting is connected to the first side wall of the first sleeve and the second side wall of the second sleeve by hooks.

16. The product transfer system of claim 13 wherein the first netting extends from the first side wall of the first sleeve to the second side wall of the first sleeve.

17. The product transfer system of claim 13 comprising a first top cap on the first sleeve and a second top cap on the second sleeve.

18. The product transfer system of claim 2 wherein the pallet is a molded plastic.

19. The product transfer system of claim 3 wherein the upper portion of the dolly is a molded plastic.

20. The product transfer system of claim 1 wherein the first sleeve is secured to the first base member by a first latch and the second sleeve is secured to the second base member by a second latch.
